(19) United States
(12) Patent Application Publication
(10) Pub. No.: US 2024/0202087 A1
(43) Pub. Date: Jun. 20, 2024

(54) ROUTING RAW DEBUG DATA USING TRACE INFRASTRUCTURE IN PROCESSOR-BASED DEVICES

(71) Applicant: QUALCOMM Incorporated, San Diego, CA (US)

(72) Inventors: Sreeram Jayadev, Austin, TX (US); Vinod Chamarty, Campbell, CA (US)

(21) Appl. No.: 18/498,583

(22) Filed: Oct. 31, 2023

Related U.S. Application Data
(60) Provisional application No. 63/476,046, filed on Dec. 19, 2022.

(51) Int. Cl. G06F 11/22

(52) U.S. Cl. CPC G06F 11/2221

(57) ABSTRACT

Routing raw debug data using trace infrastructure in processor-based devices is disclosed. In some aspects, a processor-based device comprises a trace interconnect bus, a subsystem circuit comprising a debug transmit circuit, and an input/output (I/O) endpoint circuit. The debug transmit circuit is configured to receive raw debug data from the subsystem circuit, and generate a debug trace packet comprising the raw debug data in lieu of formatted trace data. The debug transmit circuit is also configured to transmit the debug trace packet comprising the raw debug data to the I/O endpoint circuit via the trace interconnect bus during a period of trace interconnect bus inactivity. In this manner, an existing trace infrastructure can be employed to transmit raw debug data without incurring expense in terms of overhead and monetary cost due to the need for industry-standard, infrastructure-compliant tools to decode conventionally packetized trace data for analysis.

### PRIORITY CLAIM

The present application claims priority to U.S. Provisional Patent Application Ser. No. 63/476,046, filed on Dec. 19, 2022 and entitled “ROUTING RAW DEBUG DATA USING TRACE INFRASTRUCTURE IN PROCESSOR-BASED DEVICES,” the contents of which is incorporated herein by reference in its entirety.

### BACKGROUND

### I. Field of the Disclosure

The technology of the disclosure relates to debugging mechanisms in processor-based devices, and, in particular, to transmission of data using trace infrastructure.

### II. Background

A conventional processor-based device, such as a System-on-Chip (SoC), generally is subdivided into multiple subsystem circuits or “blocks” that each provide a specific functionality. Because the inner workings of a given subsystem circuit may be opaque to outside observation, the processor-based device may provide a trace infrastructure that enables non-invasive debugging of the subsystem circuit. In this regard, the trace infrastructure includes mechanisms for self-hosted debugging, discovery of debugging components, processor execution trace, and software instrumentation to support the collection of trace data relating to instruction execution and data transfers within the subsystem circuit. The trace infrastructure further includes a trace interconnect bus to handle data transmission and clock and power domain crossing, and also provides one or more trace sinks to collect trace data. The trace sinks may comprise, as non-limiting examples, a system memory device and/or an embedded trace buffer in which trace data may be stored on-chip, and/or a Trace Port Interface Unit (TPIU) that sends trace data to General Purpose Input/Output (GPIO) pins to which off-chip external analytical equipment can be connected. Conventional trace infrastructures include the ARM Coresight trace infrastructure, which utilizes a standard Advanced Microcontroller Bus Architecture (AMBA) trace bus protocol called AMBA Trace Bus (ATB) protocol.

Trace infrastructures such as ARM Coresight generally require trace data to be packetized into trace packets that conform to a specific trace format specified by the underlying trace architecture. In some circumstances, though, it may be desirable to access debug data, such as error bits, Finite State Machine (FSM) encodings, and/or interrupt signals, generated by the subsystem circuit in a raw state that does not conform with the trace format. The use of the trace infrastructure to packetize and transmit raw debug data as conventional trace packets in such cases may incur additional expense in terms of overhead and monetary cost due to the need for industry-standard, infrastructure-compliant tools to decode the packetized trace data for analysis.

### SUMMARY OF THE DISCLOSURE

Aspects disclosed in the detailed description include routing raw debug data using trace infrastructure in processor-based devices. Related apparatus and methods are also disclosed. In this regard, in some exemplary aspects disclosed herein, a processor-based device is subdivided into one or more subsystem circuits that each comprise a debug transmit circuit. The debug transmit circuit is configured to receive raw debug data from the subsystem circuit, and generate a debug trace packet that comprises the raw debug data in lieu of formatted trace data. As used herein, a “debug trace packet” comprises a packet of data that meets minimum requirements specified by the trace architecture of the processor-based device to be transmitted using a trace interconnect bus of the processor-based device, but that otherwise does not contain formatted trace data as specified by the trace architecture. The debug transmit circuit uses the trace interconnect bus to transmit the debug trace packet comprising the raw debug data to an input/output (I/O) endpoint circuit of the processor-based device during a period of trace interconnect bus inactivity (e.g., during a boot stage of the processor-based device). The trace interconnect bus in some aspects may comprise an Advanced Microcontroller Bus Architecture (AMBA) trace bus (ATB) interconnect bus. In this manner, an existing trace infrastructure can be employed to transmit raw debug data without incurring expense in terms of overhead and monetary cost due to the need for industry-standard, infrastructure-compliant tools to decode conventionally packetized trace data for analysis.

In some aspects, the functionality of the debug transmit circuit may be selectively enabled through the use of a debug enable signal that may be sent by, e.g., firmware of the processor-based device. Upon receiving the debug enable signal, the debug transmit circuit selectively enables the debug functionality of the debug transmit circuit. To avoid the need to send an identifier for the subsystem circuit sending the raw debug data, the processor-based device may be configured to selectively enable only the debug transmit circuit among a plurality of debug transmit circuits. According to some aspects, the debug transmit circuit, in response to receiving the debug enable signal, may transmit a training pattern to the I/O endpoint circuit. If the I/O endpoint circuit is one of multiple I/O endpoint circuits receiving the raw debug data, the training pattern may be used, e.g., by external equipment to synchronize access to the raw debug data received by the multiple I/O endpoint circuits.

Some aspects may provide that the I/O endpoint circuit comprises a debug receive circuit that is configured to receive the debug trace packet comprising the raw debug data from the debug transmit circuit. The debug receive circuit extracts the raw debug data from the debug trace packet, and transmits the raw debug data to a trace sink. According to some aspects, the debug receive circuit comprises one or more I/O configuration registers that specify, e.g., one or more of a number of General Purpose I/O (GPIO) pins and/or an identification of one or more bits of the raw debug data to be transmitted via the GPIO pins. In such aspects, the debug receive circuit may be configured to extract the raw debug data from the debug trace packet and/or transmit the raw debug data to the trace sink based on the I/O configuration register(s).

In another aspect, a processor-based device is provided. The processor-based device comprises a trace interconnect bus, a subsystem circuit comprising a debug transmit circuit, and an I/O endpoint circuit. The debug transmit circuit is configured to receive raw debug data from the subsystem circuit. The debug transmit circuit is further configured to generate a debug trace packet comprising the raw debug data in lieu of formatted trace data. The debug transmit circuit is also configured to transmit the debug trace packet comprising the raw debug data to the I/O endpoint circuit via the trace interconnect bus during a period of trace interconnect bus inactivity.

In another aspect, a processor-based device is provided. The processor-based device comprises means for receiving raw debug data from a subsystem circuit of the processor-based device. The processor-based device further comprises means for generating a debug trace packet comprising the raw debug data in lieu of formatted trace data. The processor-based device also comprises means for transmitting, via a trace interconnect bus of the processor-based device, the debug trace packet comprising the raw debug data to an I/O endpoint circuit of the processor-based device during a period of trace interconnect bus inactivity.

In another aspect, a method for routing raw debug data using trace infrastructure in processor-based devices is provided. The method comprises receiving, by a debug transmit circuit of a subsystem circuit of a processor-based device, raw debug data from the subsystem circuit. The method further comprises generating, by the debug transmit circuit, a debug trace packet comprising the raw debug data in lieu of formatted trace data. The method also comprises transmitting, by the debug transmit circuit via a trace interconnect bus of the processor-based device, the debug trace packet comprising the raw debug data to an I/O endpoint circuit of the processor-based device during a period of trace interconnect bus inactivity.

### BRIEF DESCRIPTION OF THE FIGURES

FIG. 1 is a block diagram of an exemplary processor-based device including a debug transmit circuit that is configured to route raw debug data using trace infrastructure, according to some aspects;

FIGS. 2A-2B are flowcharts illustrating exemplary operations by the processor-based device of FIG. 1 for routing raw debug data using trace infrastructure, according to some aspects; and

FIG. 3 is a block diagram of an exemplary processor-based device that can include the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include routing raw debug data using trace infrastructure in processor-based devices. Related apparatus and methods are also disclosed. In this regard, in some exemplary aspects disclosed herein, a processor-based device is subdivided into one or more subsystem circuits that each comprise a debug transmit circuit. The debug transmit circuit is configured to receive raw debug data from the subsystem circuit, and generate a debug trace packet that comprises the raw debug data in lieu of formatted trace data. As used herein, a “debug trace packet” comprises a packet of data that meets minimum requirements specified by the trace architecture of the processor-based device to be transmitted using a trace interconnect bus of the processor-based device, but that otherwise does not contain formatted trace data as specified by the trace architecture. The debug transmit circuit uses the trace interconnect bus to transmit the debug trace packet comprising the raw debug data to an input/output (I/O) endpoint circuit of the processor-based device during a period of trace interconnect bus inactivity (e.g., during a boot stage of the processor-based device). The trace interconnect bus in some aspects may comprise an Advanced Microcontroller Bus Architecture (AMBA) trace bus (ATB) interconnect bus. In this manner, an existing trace infrastructure can be employed to transmit raw debug data without incurring expense in terms of overhead and monetary cost due to the need for industry-standard, infrastructure-compliant tools to decode conventionally packetized trace data for analysis.

In some aspects, the functionality of the debug transmit circuit may be selectively enabled through the use of a debug enable signal that may be sent by, e.g., firmware of the processor-based device. Upon receiving the debug enable signal, the debug transmit circuit selectively enables the debug functionality of the debug transmit circuit. To avoid the need to send an identifier for the subsystem circuit sending the raw debug data, the processor-based device may be configured to selectively enable only the debug transmit circuit among a plurality of debug transmit circuits. According to some aspects, the debug transmit circuit, in response to receiving the debug enable signal, may transmit a training pattern to the I/O endpoint circuit. If the I/O endpoint circuit is one of multiple I/O endpoint circuits receiving the raw debug data, the training pattern may be used, e.g., by external equipment to synchronize access to the raw debug data received by the multiple I/O endpoint circuits.

Some aspects may provide that the I/O endpoint circuit comprises a debug receive circuit that is configured to receive the debug trace packet comprising the raw debug data from the debug transmit circuit. The debug receive circuit extracts the raw debug data from the debug trace packet, and transmits the raw debug data to a trace sink. According to some aspects, the debug receive circuit comprises one or more I/O configuration registers that specify, e.g., one or more of a number of General Purpose I/O (GPIO) pins and/or an identification of one or more bits of the raw debug data to be transmitted via the GPIO pins. In such aspects, the debug receive circuit may be configured to extract the raw debug data from the debug trace packet and/or transmit the raw debug data to the trace sink based on the I/O configuration register(s).

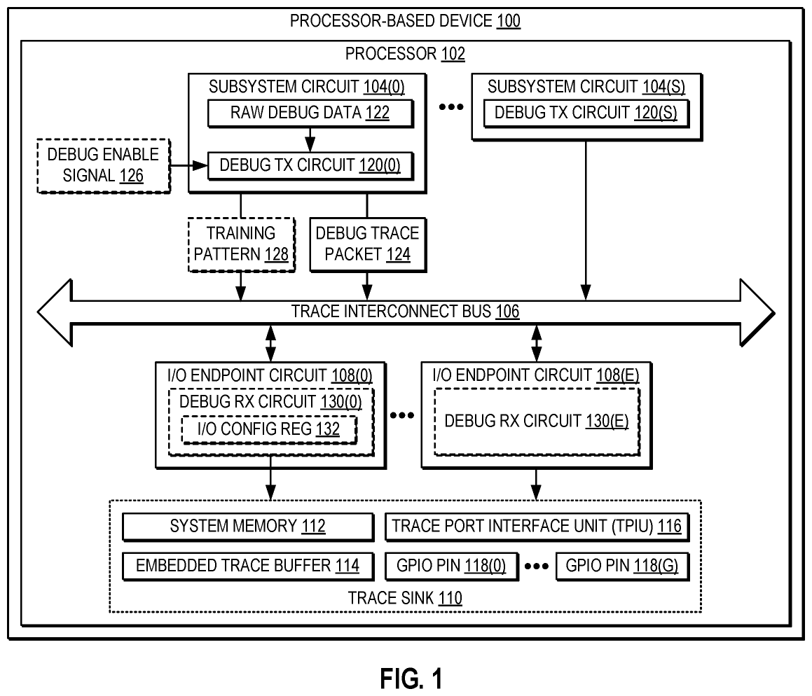

In this regard, FIG. 1 illustrates an exemplary processor-based device 100 that provides a processor 102 for routing raw debug data using trace infrastructure. The processor 102 in some aspects may comprise a central processing unit (CPU) having one or more processor cores, and in some exemplary aspects may be one of a plurality of similarly configured processors (not shown) of the processor-based device 100. The processor 102 of FIG. 1 is subdivided into a plurality of subsystem circuits 104(0)-104(S) that each provides a specific functionality of the processor 102, such as memory controller subsystems, I/O controller subsystems, and the like, as non-limiting examples.

To enable non-invasive debugging of the subsystem circuits 104(0)-104(S), the processor 102 provides a trace infrastructure that includes a trace interconnect bus 106. In some aspects, the trace infrastructure may comprise the ARM Coresight trace infrastructure, and the trace interconnect bus 106 thus may comprise a 128-bit ATB interconnect bus. The trace interconnect bus 106 is configured to route packetized trace data (not shown) from the subsystem circuits 104(0)-104(S) to a plurality of I/O endpoint circuits 108(0)-108(E), and also to handle clock and domain crossing issues that may arise between the subsystem circuits 104(0)-104(S), the trace interconnect bus 106 itself, and the I/O endpoint circuits 108(0)-108(E). In conventional use, firmware may program the trace interconnect bus 106 to specify one or more of the I/O endpoint circuits 108(0)-108(E) to which trace data is to be sent in the form of conventional trace packets. It is to be understood that the trace infrastructure of the processor 102 may comprise additional elements, such as but not limited to a top-level control architecture, mechanisms for self-debugging and discovery of debug components in the processor 102, and mechanisms for processor execution trace and software instrumentation, which are not shown in FIG. 1 for the sake of clarity.

The I/O endpoint circuits 108(0)-108(E) each comprise a destination to which conventional trace packets may be directed via the trace interconnect bus 106 by the subsystem circuits 104(0)-104(S) and encapsulate functionality for outputting trace packets to a trace sink 110. As used herein, the term “trace sink” refers generally to one or more potential destinations for trace packets. In some aspects, the trace sink 110 may be an on-chip system memory device (captioned as “SYSTEM MEMORY” in FIG. 1) 112, which may comprise, as a non-limiting example, Double Data Rate Synchronous Dynamic Random-Access Memory (DDR SDRAM). The trace sink 110 according to some aspects may be an embedded trace buffer 114, which comprises a dedicated on-chip memory device for storing trace data. Some aspects may provide that the trace sink 110 comprises a Trace Port Interface Unit (TPIU) 116, through which trace data may be sent to a plurality of GPIO pins 118(0)-118(G). Although not shown in FIG. 1, it is to be understood that external equipment, such as a waveform viewer or an oscilloscope, can be communicatively coupled to the GPIO pins 118(0)-118(G) to receive trace data for analysis and/or display.

The processor-based device 100 of FIG. 1 may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include more or fewer elements than illustrated in FIG. 1. For example, the processor 102 may further include more or fewer memory devices, execution pipeline circuits, controller circuits, buffers, and/or caches, which are omitted from FIG. 1 for the sake of clarity.

As noted above, conventional trace infrastructures generally require trace data to be packetized into trace packets that conform to a specific trace format specified by the underlying trace architecture. However, the use of the trace infrastructure to packetize and transmit raw debug data (i.e., data such as error bits, Finite State Machine (FSM) encodings, and/or interrupt signals, that are generated by a subsystem circuit in a raw state that does not conform with the trace format) may incur additional expense in terms of overhead and monetary cost due to the need for industry-standard, infrastructure-compliant tools to decode the packetized trace data for analysis.

Accordingly, in this regard, the processor 102 is configured to provide debug transmit circuits (captioned as “DEBUG TX CIRCUIT” in FIG. 1) 120(0)-120(S) as part of one or more of the subsystem circuits 104(0)-104(S). In the example of FIG. 1, the debug transmit circuit 120(0) of the subsystem circuit 104(0) is configured to receive raw debug data 122 from the subsystem circuit 104(0). The raw debug data 122 may comprise any internal data or signals generated by the internal operations of the subsystem circuit 104(0), and, in some aspects, may be received as 32-bit data values that may be stored in a buffer or queue (not shown) of the debug transmit circuit 120(0). The debug transmit circuit 120(0) generates a debug trace packet 124 that comprises the raw debug data 122 in lieu of formatted trace data (i.e., the debug trace packet 124 contains the raw debug data 122 in the place of the contents of a conventional trace packet as specified by an underlying trace architecture of the processor 102). The debug transmit circuit 120(0) next transmits the debug trace packet 124 to one or more of the plurality of I/O endpoint circuits 108(0)-108(E) via the trace interconnect bus 106 during a period of trace interconnect bus 106 inactivity. The period of trace interconnect bus 106 inactivity may be any period during which the trace interconnect bus 106 would otherwise be idle, such as a boot stage of the processor-based device 100. The debug trace packet 124 in some aspects may be routed to one or more of the I/O endpoint circuits 108(0)-108(E) using conventional techniques by which firmware (not shown) can program the trace interconnect bus 106.

In some aspects, the functionality of the debug transmit circuit 120(0) may be provided in addition to conventional trace functionality such as that provided by the ARM Coresight trace infrastructure. Thus, in such aspects, the functionality of the debug transmit circuit 120(0) may be selectively enabled through the use of a debug enable signal 126 sent by, e.g., firmware (not shown). Upon receiving the debug enable signal 126, the debug transmit circuit 120(0) selectively enables the debug functionality of the debug transmit circuit 120(0) in place of the conventional trace functionality. Some aspects may provide that selectively enabling the debug functionality of the debug transmit circuit 120(0) comprises selectively enabling only the debug transmit circuit 120(0) among the plurality of debug transmit circuits 120(0)-120(S), such that the debug transmit circuit 120(0) is the only one of the debug transmit circuits 120(0)-120(S) that can transmit debug trace packets via the trace interconnect bus 106 at a given time. This contrasts with conventional trace infrastructures in which multiple sources of trace data may transmit trace data, along with corresponding source identifiers, via the trace interconnect bus 106 in an interleaved fashion. By limiting transmission of debug trace packets to only one of the debug transmit circuits 120(0)-120(S) at a time, aspects disclosed therein can avoid the need to include an identifier of the source of the debug trace packet 124.

Because the I/O endpoint circuits 108(0)-108(E) may be located at varying distances from the debug transmit circuit 120(0) sending the debug trace packet 124, the time at which different I/O endpoint circuits 108(0)-108(E) receive the debug trace packet 124 may vary. Accordingly, to enable an observer to account for differences in reception time among the I/O endpoint circuits 108(0)-108(E), some aspects of the debug transmit circuit 120(0) may provide that, in response to receiving the debug enable signal 126, the debug transmit circuit 120(0) sends a training pattern 128 to the I/O endpoint circuits 108(0)-108(E). The training pattern 128 may be any pre-specified pattern of bits or signals and may be sent multiple times to the I/O endpoint circuits 108(0)-108(E) prior to sending the debug trace packet 124. An observer (not shown) connected to the I/O endpoint circuits 108(0)-108(E) can then look for the training pattern 128 in the data received from each of one or more of the I/O endpoint circuits 108(0)-108(E). Upon recognizing the training pattern 128, the observer can measure differences in reception time among the I/O endpoint circuits 108(0)-108(E) and can use the measured differences to synchronize data received from the I/O endpoint circuits 108(0)-108(E).

According to some aspects, each of the I/O endpoint circuits 108(0)-108(E) comprises a corresponding debug receive circuit (captioned as “DEBUG RX CIRCUIT” in FIG. 1) 130(0)-130(E) that is configured to receive debug trace packets from the debug transmit circuits 120(0)-120(S). Thus, in the example of FIG. 1, the debug receive circuit 130(0) receives the debug trace packet 124 from the debug transmit circuit 120(0). The debug receive circuit 130(0) extracts the raw debug data 122 from the debug trace packet 124 and transmits the raw debug data 122 to the trace sink 110 (i.e., to one or more of the system memory 112, the embedded trace buffer 114, the TPIU 116, and the GPIO pins 118(0)-118(G)). The debug receive circuit 130(0) according to some aspects may be configured to handle clock crossing issues that may arise due to differences in clock speed between, e.g., the trace interconnect bus 106 clock domain and the GPIO pins 118(0)-118(G) clock domain.

In some aspects, each of the debug receive circuits 130(0)-130(E) may be configured to access only a portion of the raw debug data 122 and/or transmit data to only a subset of the GPIO pins 118(0)-118(G). In such aspects, the debug receive circuit 130(0) may comprise a I/O configuration register (captioned as “I/O CONFIG REG” in FIG. 1) 132 that may be set by firmware (not shown) to specify, e.g., one or more of a number of the GPIO pins 118(0)-118(E) to which the debug receive circuit 130(0) will write data, and/or an identification of one or more bits of the raw debug data 122 to be output by the debug receive circuit 130(0). Such aspects may further provide that the operations for extracting the raw debug data 122 and transmitting the raw debug data 122 to the trace sink 110 may be performed based on the I/O configuration register 132. It is to be understood that, while FIG. 1 illustrates only a single I/O configuration register 132, some aspects may provide multiple I/O configuration registers 132.

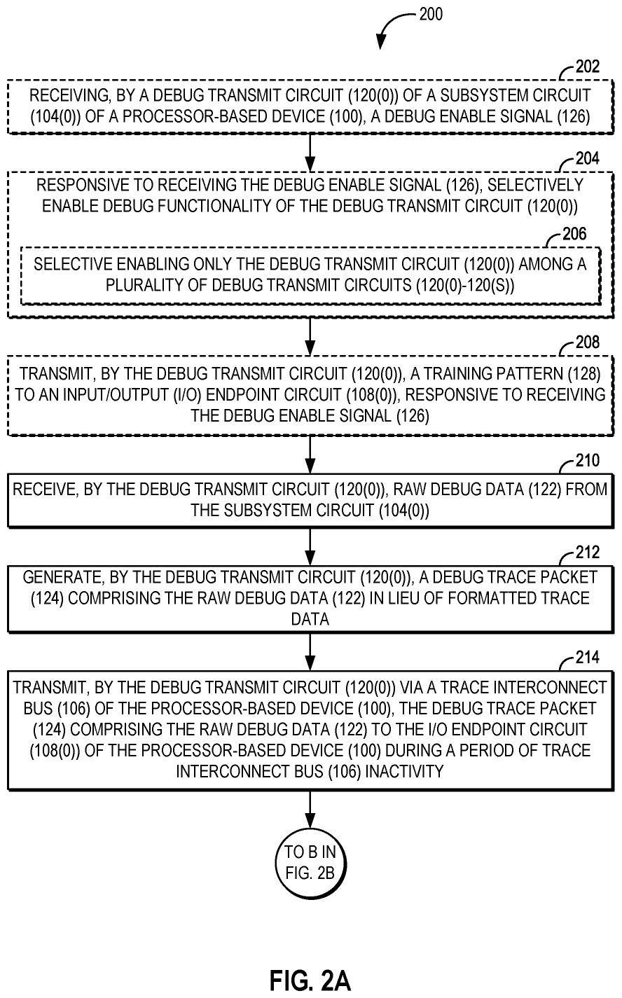

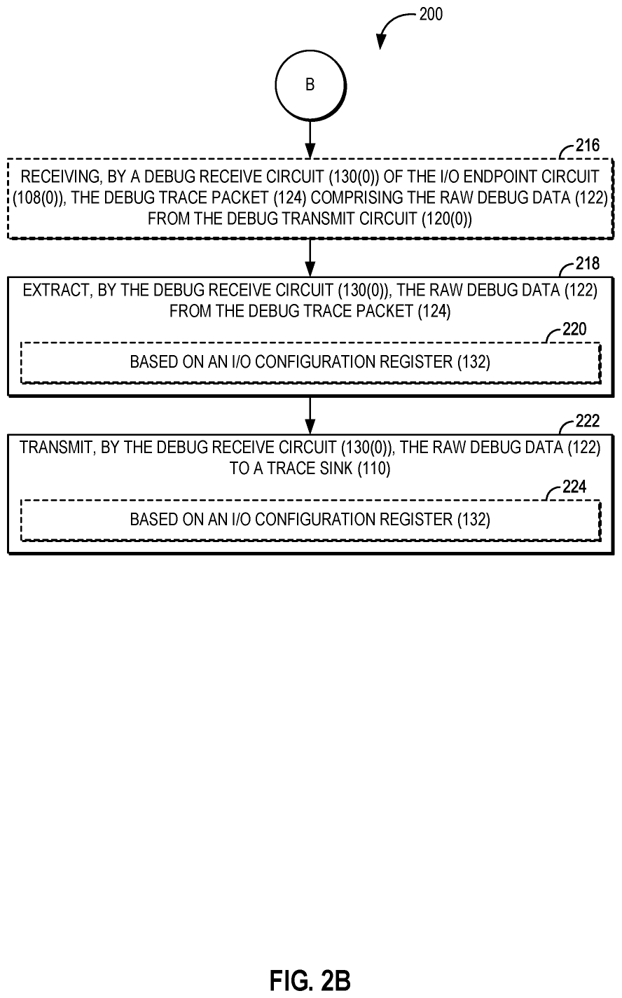

To further describe operations of the processor-based device 100 of FIG. 1 for routing raw debug data using trace infrastructure, FIGS. 2A-2B provide a flowchart illustrating exemplary operations 200. For the sake of clarity, elements of FIG. 1 are referenced in describing FIGS. 2A-2B. It is to be understood that some aspects may provide that some operations illustrated in FIGS. 2A-2B may be performed in an order other than that illustrated herein and/or may be omitted. In FIG. 2A, the exemplary operations 200 in some aspects begin with the processor-based device 100 of FIG. 1 (e.g., using the debug transmit circuit 120(0) of the subsystem circuit 104(0) of FIG. 1) receiving a debug enable signal, such as the debug enable signal 126 of FIG. 1 (block 202). In response to receiving the debug enable signal 126, the debug transmit circuit 120(0) selectively enables the debug functionality of the debug transmit circuit 120(0) (block 204). In some aspects, the operations of block 204 for enabling the debug functionality of the debug transmit circuit 120(0) may comprise selectively enabling only the debug transmit circuit 120(0) among a plurality of debug transmit circuits (e.g., the plurality of debug transmit circuits 120(0)-120(S) of FIG. 1) (block 206). Some aspects may further provide that the debug transmit circuit 120(0), in response to receiving the debug enable signal 126, transmits a training pattern (e.g., the training pattern 128 of FIG. 1) to an I/O endpoint circuit, such as the I/O endpoint circuit 108(0) of FIG. 1 (block 208).

The debug transmit circuit 120(0) receives raw debug data (e.g., the raw debug data 122 of FIG. 1) from the subsystem circuit 104(0) (block 210). The debug transmit circuit 120(0) next generates a debug trace packet (e.g., the debug trace packet 124 of FIG. 1) comprising the raw debug data 122 in lieu of formatted trace data (block 212). The debug transmit circuit 120(0) then transmits, via a trace interconnect bus (e.g., the trace interconnect bus 106 of FIG. 1) of the processor-based device 100, the debug trace packet 124 comprising the raw debug data 122 to the I/O endpoint circuit 108(0) of the processor-based device 100 during a period of trace interconnect bus 106 inactivity (block 214). The exemplary operations 200 in some aspects may then continue at block 216 of FIG. 2B.

Turning now to FIG. 2B, the exemplary operations 200 in some aspects may continue with a debug receive circuit (e.g., the debug receive circuit 130(0) of FIG. 1) of the I/O endpoint circuit 108(0) receiving the debug trace packet 124 comprising the raw debug data 122 from the debug transmit circuit 120(0) (block 216). The debug receive circuit 130(0) extracts the raw debug data 122 from the debug trace packet 124 (block 218). According to some aspects, the operations of block 218 for extracting the raw debug data 122 from the debug trace packet 124 are based on an I/O configuration register such as the I/O configuration register 132 of FIG. 1 (block 220). The debug receive circuit 130(0) then transmits the raw debug data 122 to a trace sink (e.g., the trace sink 110 of FIG. 1) (block 222). Some aspects may provide that the operations of block 222 for transmitting the raw debug data 122 to the trace sink 110 are based on the I/O configuration register 132 (block 224).

Routing raw debug data using trace infrastructure in processor-based devices as disclosed in aspects described herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

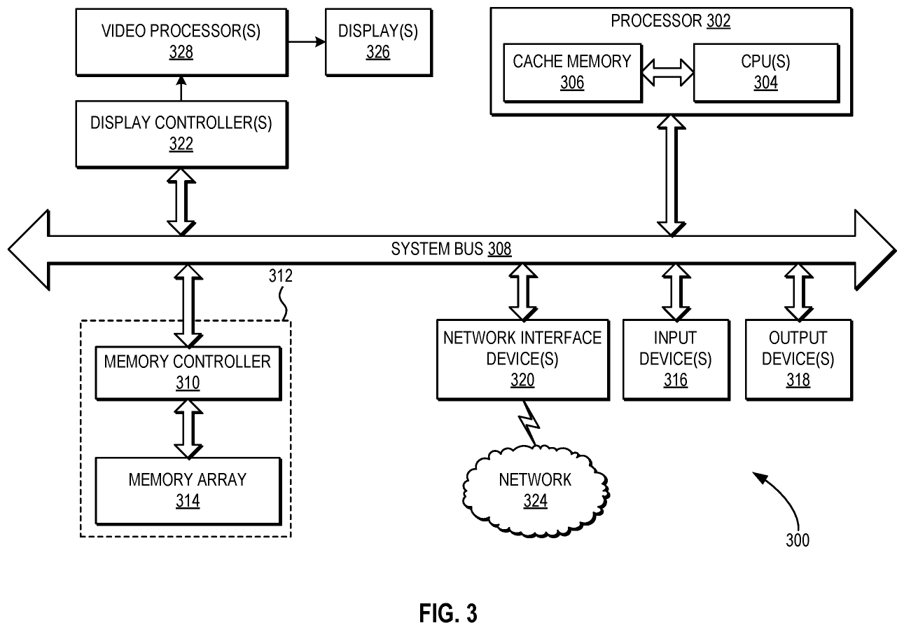

In this regard, FIG. 3 illustrates an example of a processor-based device 300 that may comprise the processor-based device 100 illustrated in FIG. 1. In this example, the processor-based device 300 includes a processor 302 that includes one or more central processing units (captioned as “CPUs” in FIG. 3) 304, which may also be referred to as CPU cores or processor cores. The processor 302 may have cache memory 306 coupled to the processor 302 for rapid access to temporarily stored data. The processor 302 is coupled to a system bus 308 and can intercouple master and slave devices included in the processor-based device 300. As is well known, the processor 302 communicates with these other devices by exchanging address, control, and data information over the system bus 308. For example, the processor 302 can communicate bus transaction requests to a memory controller 310, as an example of a slave device. Although not illustrated in FIG. 3, multiple system buses 308 could be provided, wherein each system bus 308 constitutes a different fabric.

Other master and slave devices can be connected to the system bus 308. As illustrated in FIG. 3, these devices can include a memory system 312 that includes the memory controller 310 and a memory array(s) 314, one or more input devices 316, one or more output devices 318, one or more network interface devices 320, and one or more display controllers 322, as examples. The input device(s) 316 can include any type of input device, including but not limited to input keys, switches, voice processors, etc. The output device(s) 318 can include any type of output device, including, but not limited to, audio, video, other visual indicators, etc. The network interface device(s) 320 can be any device configured to allow exchange of data to and from a network 324. The network 324 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 320 can be configured to support any type of communications protocol desired.

The processor 302 may also be configured to access the display controller(s) 322 over the system bus 308 to control information sent to one or more displays 326. The display controller(s) 322 sends information to the display(s) 326 to be displayed via one or more video processors 328, which process the information to be displayed into a format suitable for the display(s) 326. The display controller(s) 322 and/or the video processors 328 may comprise or be integrated into a GPU. The display(s) 326 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor-based device, comprising:
   a trace interconnect bus;
   a subsystem circuit comprising a debug transmit circuit; and
   an input/output (I/O) endpoint circuit;
   the debug transmit circuit configured to:
      receive raw debug data from the subsystem circuit;
      generate a debug trace packet comprising the raw debug data in lieu of formatted trace data; and
      transmit the debug trace packet comprising the raw debug data to the I/O endpoint circuit via the trace interconnect bus during a period of trace interconnect bus inactivity.
2. The processor-based device of clause 1, wherein the trace interconnect bus comprises an Advanced Microcontroller Bus Architecture (AMBA) trace bus (ATB) interconnect bus.
3. The processor-based device of any one of clauses 1-2, wherein the period of trace interconnect bus inactivity comprises a boot stage.
4. The processor-based device of any one of clauses 1-3, wherein the debug transmit circuit is further configured to:
   receive a debug enable signal; and
   responsive to receiving the debug enable signal, selectively enable debug functionality of the debug transmit circuit.
5. The processor-based device of clause 4, wherein:
   the debug transmit circuit comprises one of a plurality of debug transmit circuits of a corresponding plurality of subsystem circuits; and
   the debug transmit circuit is configured to selectively enable the debug functionality of the debug transmit circuit by being configured to selectively enable only the debug transmit circuit among the plurality of debug transmit circuits.
6. The processor-based device of any one of clauses 4-5, wherein the debug transmit circuit is further configured to transmit a training pattern to the I/O endpoint circuit, responsive to receiving the debug enable signal.
7. The processor-based device of any one of clauses 1-6, wherein the I/O endpoint circuit comprises a debug receive circuit configured to:
   receive the debug trace packet comprising the raw debug data from the debug transmit circuit;
   extract the raw debug data from the debug trace packet; and
   transmit the raw debug data to a trace sink.
8. The processor-based device of clause 7, wherein the trace sink comprises one or more of a system memory, an embedded trace buffer, a Trace Port Interface Unit (TPIU), and one or more General Purpose I/O (GPIO) pins.
9. The processor-based device of any one of clauses 7-8, wherein:
   the debug receive circuit comprises an I/O configuration register specifying one or more of a number of General Purpose I/O (GPIO) pins and an identification of one or more bits of the raw debug data; and
   the debug receive circuit is configured to extract the raw debug data and transmit the raw debug data to the trace sink based on the I/O configuration register.
10. The processor-based device of any one of clauses 1-9, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
11. A processor-based device, comprising:
   means for receiving raw debug data from a subsystem circuit of the processor-based device;
   means for generating a debug trace packet comprising the raw debug data in lieu of formatted trace data; and
   means for transmitting, via a trace interconnect bus of the processor-based device, the debug trace packet comprising the raw debug data to an I/O endpoint circuit of the processor-based device during a period of trace interconnect bus inactivity.
12. A method for routing raw debug data using trace infrastructure, comprising:
   receiving, by a debug transmit circuit of a subsystem circuit of a processor-based device, raw debug data from the subsystem circuit;
   generating, by the debug transmit circuit, a debug trace packet comprising the raw debug data in lieu of formatted trace data; and
   transmitting, by the debug transmit circuit via a trace interconnect bus of the processor-based device, the debug trace packet comprising the raw debug data to an input/output (I/O) endpoint circuit of the processor-based device during a period of trace interconnect bus inactivity.
13. The method of clause 12, wherein the trace interconnect bus comprises an Advanced Microcontroller Bus Architecture (AMBA) trace bus (ATB) interconnect bus.
14. The method of any one of clauses 12-13, wherein the period of trace interconnect bus inactivity comprises a boot stage.
15. The method of any one of clauses 12-14, further comprising:
   receiving, by the debug transmit circuit, a debug enable signal; and
   responsive to receiving the debug enable signal, selectively enabling debug functionality of the debug transmit circuit.
16. The method of clause 15, wherein:
   the debug transmit circuit comprises one of a plurality of debug transmit circuits of a corresponding plurality of subsystem circuits of the processor-based device; and
   selectively enabling debug functionality of the debug transmit circuit comprises selectively enabling only the debug transmit circuit among the plurality of debug transmit circuits.
17. The method of any one of clauses 15-16, further comprising transmitting, by the debug transmit circuit, a training pattern to the I/O endpoint circuit, responsive to receiving the debug enable signal.
18. The method of any one of clauses 12-17, further comprising:
   receiving, by a debug receive circuit of the I/O endpoint circuit, the debug trace packet comprising the raw debug data from the debug transmit circuit;
   extracting, by the debug receive circuit, the raw debug data from the debug trace packet; and
   transmitting, by the debug receive circuit, the raw debug data to a trace sink.
19. The method of clause 18, wherein the trace sink comprises one or more of a system memory, an embedded trace buffer, a Trace Port Interface Unit (TPIU), and one or more General Purpose I/O (GPIO) pins.
20. The method of any one of clauses 18-19, wherein:
   the debug receive circuit comprises an I/O configuration register specifying one or more of a number of General Purpose I/O (GPIO) pins and an identification of one or more bits of the raw debug data; and
   extracting the raw debug data comprises extracting the raw debug data based on the I/O configuration register; and
   transmitting the raw debug data to the trace sink comprises transmitting the raw debug data based on the I/O configuration register.

What is claimed is:

1. A processor-based device, comprising:
a trace interconnect bus;
a subsystem circuit comprising a debug transmit circuit; and
an input/output (I/O) endpoint circuit;
the debug transmit circuit configured to:
receive raw debug data from the subsystem circuit;
generate a debug trace packet comprising the raw debug data in lieu of formatted trace data; and
transmit the debug trace packet comprising the raw debug data to the I/O endpoint circuit via the trace interconnect bus during a period of trace interconnect bus inactivity.

2. The processor-based device of claim 1, wherein the trace interconnect bus comprises an Advanced Microcontroller Bus Architecture (AMBA) trace bus (ATB) interconnect bus.

3. The processor-based device of claim 1, wherein the period of trace interconnect bus inactivity comprises a boot stage.

4. The processor-based device of claim 1, wherein the debug transmit circuit is further configured to:
receive a debug enable signal; and
responsive to receiving the debug enable signal, selectively enable debug functionality of the debug transmit circuit.

5. The processor-based device of claim 4, wherein:
the debug transmit circuit comprises one of a plurality of debug transmit circuits of a corresponding plurality of subsystem circuits; and
the debug transmit circuit is configured to selectively enable the debug functionality of the debug transmit circuit by being configured to selectively enable only the debug transmit circuit among the plurality of debug transmit circuits.

6. The processor-based device of claim 4, wherein the debug transmit circuit is further configured to transmit a training pattern to the I/O endpoint circuit, responsive to receiving the debug enable signal.

7. The processor-based device of claim 1, wherein the I/O endpoint circuit comprises a debug receive circuit configured to:
receive the debug trace packet comprising the raw debug data from the debug transmit circuit;
extract the raw debug data from the debug trace packet; and
transmit the raw debug data to a trace sink.

8. The processor-based device of claim 7, wherein the trace sink comprises one or more of a system memory, an embedded trace buffer, a Trace Port Interface Unit (TPIU), and one or more General Purpose I/O (GPIO) pins.

9. The processor-based device of claim 7, wherein:
the debug receive circuit comprises an I/O configuration register specifying one or more of a number of General Purpose I/O (GPIO) pins and an identification of one or more bits of the raw debug data; and
the debug receive circuit is configured to extract the raw debug data and transmit the raw debug data to the trace sink based on the I/O configuration register.

10. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based device, comprising:
means for receiving raw debug data from a subsystem circuit of the processor-based device;
means for generating a debug trace packet comprising the raw debug data in lieu of formatted trace data; and
means for transmitting, via a trace interconnect bus of the processor-based device, the debug trace packet comprising the raw debug data to an I/O endpoint circuit of the processor-based device during a period of trace interconnect bus inactivity.

12. A method for routing raw debug data using trace infrastructure, comprising:
receiving, by a debug transmit circuit of a subsystem circuit of a processor-based device, raw debug data from the subsystem circuit;
generating, by the debug transmit circuit, a debug trace packet comprising the raw debug data in lieu of formatted trace data; and
transmitting, by the debug transmit circuit via a trace interconnect bus of the processor-based device, the debug trace packet comprising the raw debug data to an input/output (I/O) endpoint circuit of the processor-based device during a period of trace interconnect bus inactivity.

13. The method of claim 12, wherein the trace interconnect bus comprises an Advanced Microcontroller Bus Architecture (AMBA) trace bus (ATB) interconnect bus.

14. The method of claim 12, wherein the period of trace interconnect bus inactivity comprises a boot stage.

15. The method of claim 12, further comprising:
receiving, by the debug transmit circuit, a debug enable signal; and
responsive to receiving the debug enable signal, selectively enabling debug functionality of the debug transmit circuit.

16. The method of claim 15, wherein:
the debug transmit circuit comprises one of a plurality of debug transmit circuits of a corresponding plurality of subsystem circuits of the processor-based device; and
selectively enabling debug functionality of the debug transmit circuit comprises selectively enabling only the debug transmit circuit among the plurality of debug transmit circuits.

17. The method of claim 15, further comprising transmitting, by the debug transmit circuit, a training pattern to the I/O endpoint circuit, responsive to receiving the debug enable signal.

18. The method of claim 12, further comprising:
receiving, by a debug receive circuit of the I/O endpoint circuit, the debug trace packet comprising the raw debug data from the debug transmit circuit;
extracting, by the debug receive circuit, the raw debug data from the debug trace packet; and
transmitting, by the debug receive circuit, the raw debug data to a trace sink.

19. The method of claim 18, wherein the trace sink comprises one or more of a system memory, an embedded trace buffer, a Trace Port Interface Unit (TPIU), and one or more General Purpose I/O (GPIO) pins.

20. The method of claim 18, wherein:
the debug receive circuit comprises an I/O configuration register specifying one or more of a number of General Purpose I/O (GPIO) pins and an identification of one or more bits of the raw debug data; and
extracting the raw debug data comprises extracting the raw debug data based on the I/O configuration register; and
transmitting the raw debug data to the trace sink comprises transmitting the raw debug data based on the I/O configuration register.
